(19) United States
(12) Patent Application Publication
(10) Pub. No.: US 2024/0087868 A1
(43) Pub. Date: Mar. 14, 2024

(54) METHOD OF CONTROLLING A MULTI-POLE DEVICE TO REDUCE OMISSION OF EXITING CHARGED PARTICLES FROM DOWNSTREAM ANALYSIS

(71) Applicants: THE TRUSTEES OF INDIANA UNIVERSITY, Bloomington, IN (US); WATERS TECHNOLOGIES CORPORATION, Milford, MA (US)

(72) Inventors: Martin F. JARROLD, Bloomington, IN (US); Peyton SAYASITH, Bloomington, IN (US); Kevin GILES, Stockport (GB); David BRUTON, Congleton (GB)

(21) Appl. No.: 18/464,063

(22) Filed: Sep. 8, 2023

Related U.S. Application Data
(60) Provisional application No. 63/405,004, filed on Sep. 9, 2022.

(51) Int. Cl. H01J 49/06

(52) U.S. Cl. CPC H01J 49/06

(57) ABSTRACT

A method is provided for controlling a multi-pole charged particle transmission device having rods spaced apart radially about a central axis extending from a particle inlet at one end of the device to a particle outlet at an opposite end. An AC voltage source is controlled to apply an AC voltage having a frequency, a peak amplitude, and a waveform shape to the charged particle transmission device, and a set of charged particles is passed through the device under such conditions. The AC voltage source is then controlled to change at least one of the frequency, peak amplitude or shape of the AC, and another set of the charged particles is then passed through the charged particle transmission device under such conditions.

### CROSS-REFERENCE TO RELATED APPLICATION

This application claims the benefit of and priority to U.S. Provisional Patent Application Ser. No. 63/405,004, filed Sep. 9, 2022, the disclosure of which is incorporated herein by reference in its entirety.

### GOVERNMENT RIGHTS

This invention was made with government support under GM131100 awarded by the National Institutes of Health. The United States Government has certain rights in the invention.

### TECHNICAL FIELD

The present disclosure relates generally to charged particle analysis instruments and systems utilizing one or more multi-pole charged particle transmission devices to guide or filter charged particles prior to, or as part of, analysis of one or more charged particle characteristics, and more specifically to methods for controlling one or more such multi-pole charged particle transmission devices to reduce omission of exiting charged particles from analysis by downstream components of the charged particle analysis instrument or system.

### BACKGROUND

Multi-pole devices, such as quadrupole, hexapole, and octopole devices, are conventionally used in charged particle analysis systems to guide charged particles having a wide range of mass-to-charge ratios or to filter charged particles so as to transmit to downstream components only charged particles having a reduced range of mass-to-charge ratios. It is desirable to control such multi-pole devices in a manner, which avoids, or at least reduces, inadvertent omission of exiting charged particles from analysis by downstream components of the charged particle analysis system.

### SUMMARY

The present disclosure may comprise one or more of the features recited in the attached claims, and/or one or more of the following features and combinations thereof. In a first aspect, a method is provided for controlling a multi-pole charged particle transmission device having an even number of elongated rods spaced apart radially about a central axis extending axially through the device from a charged particle inlet at one end of the device to a charged particle outlet at an opposite end of the device. The method may comprise controlling an AC voltage source to apply an AC voltage, having a frequency set to a first frequency, having a peak amplitude set to a first amplitude and having a waveform shape set to a first waveform shape, to the rods of the multi-pole charged particle transmission device, passing a set of charged particles through the charged particle transmission device with the frequency of the applied AC voltage at the first frequency, with the peak amplitude of the applied AC voltage at the first amplitude, and with the waveform shape of the AC voltage set to the first waveform shape, controlling the AC voltage source to change one of the frequency of the AC voltage to a second frequency different from the first frequency, the peak amplitude of the AC voltage to a second amplitude different from the first amplitude, or the waveform shape of the AC voltage to a second waveform shape different from the first waveform shape, and passing another set of the charged particles through the charged particle transmission device with the one of the frequency of the applied AC voltage at the second frequency, the peak amplitude of the applied AC voltage at the second amplitude, or the waveform shape of the AC voltage having the second waveform shape.

A second aspect may include the features of the first aspect, and may further comprise, prior to controlling the AC source to change the one of the frequency of the AC voltage to the second frequency or the peak amplitude of the AC voltage to the second amplitude, (i) controlling the AC voltage source to advance the one of the frequency of the applied AC voltage by a first selected step size toward the second frequency, or the peak amplitude of the AC voltage by the first selected step size to toward the second amplitude, followed by (ii) passing a new set of the charged particles through the charged particle transmission device with the one of the frequency of the applied AC voltage at the advanced frequency, or the peak amplitude of the AC voltage at the advanced amplitude, and (iii) executing (i) and (ii) until the one of the advanced frequency reaches the second frequency, or the advanced amplitude reaches the second amplitude.

A third aspect may include the features of the second aspect, and may further comprise, after the one of the advanced frequency reaches the second frequency, or the advanced amplitude reaches the second amplitude, (iv) controlling the AC voltage source to advance the one of the frequency of the applied AC voltage by a second selected step size back toward the first frequency, or the peak amplitude of the AC voltage by the second selected step size back toward the first amplitude, followed by (v) passing another new set of the charged particles through the charged particle transmission device with the one of the frequency of the applied AC voltage at the advanced frequency, or the peak amplitude of the AC voltage at the advanced amplitude, and (vi) executing (iv) and (v) until the one of the advanced frequency reaches the first frequency, or the peak amplitude reaches the first amplitude.

A fourth aspect may include the features of the third aspect, and may further comprise executing a selected number of times, (i)-(iii) and followed by (iv)-(vi).

A fifth aspect may include the features of the second aspect, and may further comprise completing (iii) within a selected time period.

A sixth aspect may include the features of the third aspect, and may further comprise completing (vi) within a selected time period.

A seventh aspect may include the features of the third or fourth aspect, and may further comprise completing each execution of (i)-(iii) and (iv)-(vi) within a selected time period.

An eighth aspect may include the features of any of the first through seventh aspects, and wherein controlling the AC voltage source may comprise controlling the AC voltage source to change the frequency of the AC voltage, and the method may further comprise: selecting a base frequency of the AC voltage produced by the AC voltage source as a function of mass-to-charge ratios of the charged particles to be passed through the multi-pole charged particle transmission device, and selecting the first and second frequencies, wherein the second frequency is greater than the first frequency, such that the base frequency is between the first and second frequencies, such that the base frequency is the first frequency, or such that the base frequency is the second frequency.

A ninth aspect may include the features of any of the first through seventh aspects, and wherein controlling the AC voltage source may comprise controlling the AC voltage source to change the peak amplitude of the AC voltage, and the method may further comprise: selecting a base peak amplitude of the AC voltage produced by the AC voltage source as a function of mass-to-charge ratios of the charged particles to be passed through the multi-pole charged particle transmission device, and selecting the first and second amplitudes, wherein the second amplitude is greater than the first amplitude, such that the base peak amplitude is between the first and second amplitudes, such that the base peak amplitude is the first amplitude, or such that the base peak amplitude is the second amplitude.

A tenth aspect may include the features of any of the first through ninth aspects, and wherein only the AC voltage is applied to the rods such that the multi-pole charged particle transmission device operates as a multi-pole charged particle guide.

An eleventh aspect may include the features of any of the first through ninth aspects, and may further comprise controlling a DC voltage source to also apply a DC voltage to the rods of the multi-pole charged particle transmission device such that the multi-pole charged particle transmission device operates as a multi-pole charged particle mass-to-charge ratio filter.

A twelfth aspect may include the features of the eleventh aspect, and may further comprise selecting a magnitude of the DC voltage which defines a corresponding range of mass-to-charge ratios to pass through the multi-pole charged particle mass-to-charge ratio filter, and controlling the DC voltage source to apply the DC voltage with the selected magnitude to the rods of the multi-pole charged particle mass-to-charge ratio filter so as to pass through the multi-pole charged particle mass-to-charge ratio filter only charged particles having mass-to-charge ratios within the corresponding range of mass-to-charge ratios.

In a thirteenth aspect, a method is provided for analyzing charged particles generated by a source of charged particles. The method may comprise receiving the generated charged particles in the charged particle inlet of the multi-pole charged particle transmission device, controlling a multi-pole charged particle transmission device according to any of the first through twelfth aspects, for each set of charged particles passing through the multi-pole charged particle transmission device, measuring with at least one charged particle analyzer mass-to-charge ratios of the charged particles in the respective set of charged particles exiting the charged particle outlet of the multi-pole charged particle transmission device, and averaging the measured mass-to-charge ratios of the charged particles in all of the respective sets of charged particles to produce a resulting set of mass-to-charge ratios of the generated charged particles.

A fourteenth aspect may include the features of the thirteenth aspect, and may further comprise, for each set of charged particles passing through the multi-pole charged particle transmission device, measuring with the at least one charged particle analyzer, charge magnitudes of the charged particles in the respective set of charged particles exiting the charged particle outlet of the multi-pole charged particle transmission device, and averaging the measured charge magnitudes of the charged particles in all of the respective sets of charged particles to produce a resulting set of charge magnitudes of the generated charged particles.

A fifteenth aspect may include the features of the fourteenth aspect, and may further comprise determining, from the resulting set of mass-to-charge ratios and the resulting set of charge magnitudes, a resulting set of masses of the generated charged particles.

In a sixteenth aspect, a method is provided for analyzing a sample. The method may comprise controlling a charged particle source to generate charged particles from the sample, receiving the generated charged particles in a charged particle inlet of a multi-pole charged particle transmission device having an even number of elongated rods spaced apart radially about a central axis extending axially through the device from the charged particle inlet at one end of the device to a charged particle outlet at an opposite end of the device, controlling an AC voltage source to apply to the rods of the multi-pole charged particle transmission device an AC voltage having a frequency set to a first frequency, a peak amplitude set to a first amplitude, and a waveform shape set to a first waveform shape, passing a set of the generated charged particles through the charged particle transmission device with the frequency of the applied AC voltage at the first frequency, the peak amplitude of the applied AC voltage at the first amplitude, and the waveform shape of the applied AC voltage having the first waveform shape, measuring, with at least one charged particle analyzer, mass-to-charge ratios of the charged particles in the set of charged particles exiting the charged particle outlet of the multi-pole charged particle transmission device, controlling the AC voltage source to change one of the frequency of the AC voltage to a second frequency different from the first frequency, the peak amplitude of the AC voltage to a second amplitude different from the first amplitude, or the waveform shape of the AC voltage to a second waveform shape different from the first waveform shape, passing another set of the charged particles through the charged particle transmission device with the one of the frequency of the applied AC voltage at the second frequency, the peak amplitude of the applied AC voltage at the second amplitude, or the waveform shape of the applied AC voltage having the second waveform shape, measuring with at least one charged particle analyzer mass-to-charge ratios of the charged particles in the another set of charged particles exiting the charged particle outlet of the multi-pole charged particle transmission device, and averaging the measured mass-to-charge ratios of the charged particles in the set and the another set of charged particles to produce a resulting set of mass-to-charge ratios of the generated charged particles.

A seventeenth aspect may include the features of the sixteenth aspect, and may further comprise measuring with the at least one charged particle analyzer charge magnitudes of the charged particles in the set of charged particles exiting the charged particle outlet of the multi-pole charged particle transmission device, measuring with the at least one charged particle analyzer charge magnitudes of the charged particles in the another set of charged particles exiting the charged particle outlet of the multi-pole charged particle transmission device, and averaging the measured charge magnitudes of the charged particles in the set and the another set of charged particles to produce a resulting set of charge magnitudes of the generated charged particles.

An eighteenth aspect may include the features of the seventeenth aspect, and may further comprise determining, from the resulting set of mass-to-charge ratios and the resulting set of charge magnitudes, a resulting set of masses of the generated charged particles.

A nineteenth aspect may include the features of the sixteenth or seventeenth aspects, and may further comprise, prior to controlling the AC source to change the one of the frequency of the AC voltage to the second frequency or the peak amplitude of the AC voltage to the second amplitude, (i) controlling the AC voltage source to advance the one of the frequency of the applied AC voltage by a first selected step size toward the second frequency, or the peak amplitude of the applied AC voltage by the first selected step size toward the second amplitude, followed by (ii) passing a new set of the charged particles through the charged particle transmission device with the one of the frequency of the applied AC voltage at the advanced frequency, or the peak amplitude of the AC voltage at the advanced amplitude, followed by (iii) measuring with the at least one charged particle analyzer mass-to-charge ratios of the charged particles in the new set of charged particles exiting the charged particle outlet of the multi-pole charged particle transmission device, and (iv) executing (i) through (iii) until the one of the advanced frequency reaches the second frequency or the advanced amplitude reaches the second amplitude, wherein averaging the measured mass-to-charge ratios comprises averaging the measured mass-to-charge ratios of the charged particles in the set of charged particles, in the another set of charged particles and in all of the new sets of charged particles to produce the resulting set of mass-to-charge ratios of the generated charged particles.

A twentieth aspect may include the features of the nineteenth aspect, and wherein (iii) further comprises measuring with the at least one charged particle analyzer charge magnitudes of the charged particles in the new set of charged particles exiting the charged particle outlet of the multi-pole charged particle transmission device, and wherein averaging the measured charge magnitudes comprises averaging the measured charge magnitudes of the charged particles in the set of charged particles, in the another set of charged particles and in all of the new sets of charged particles to produce the resulting set of charge magnitudes of the generated charged particles.

A twenty first aspect may include the features of the nineteenth aspect or the twentieth aspect, and may further comprise, after the one of the advanced frequency reaches the second frequency or the advanced amplitude reaches the second amplitude, (v) controlling the AC voltage source to advance the one of the frequency of the applied AC voltage by a second selected step size back toward the first frequency, following, or to advance the peak amplitude of the applied AC voltage by the second selected step size back toward the first amplitude, by (vi) passing another new set of the charged particles through the charged particle transmission device with the one of the frequency of the applied AC voltage at the advanced frequency, or with the peak amplitude of the applied AC voltage at the advanced amplitude, (vii) measuring with the at least one charged particle analyzer mass-to-charge ratios of the charged particles in the another new set of charged particles exiting the charged particle outlet of the multi-pole charged particle transmission device, and (viii) executing (v) through (vii) until the one of the advanced frequency reaches the first frequency or the advanced amplitude reaches the first amplitude, wherein averaging the measured mass-to-charge ratios comprises averaging the measured mass-to-charge ratios of the charged particles in the set of charged particles, in the another set of charged particles, in all of the new sets of charged particles and in all of the another new sets of charged particles to produce the resulting set of mass-to-charge ratios of the generated charged particles.

A twenty second aspect may include the features of the twenty first aspect, and wherein (vii) further comprises measuring with the at least one charged particle analyzer charge magnitudes of the charged particles in the another new set of charged particles exiting the charged particle outlet of the multi-pole charged particle transmission device, and wherein averaging the measured charge magnitudes comprises averaging the measured charge magnitudes of the charged particles in the set of charged particles, in the another set of charged particles, in all of the new sets of charged particles and in all of the another new sets of charged particles to produce the resulting set of charge magnitudes of the generated charged particles.

A twenty third aspect may include the features of the twenty first aspect or the twenty second aspect, and may further comprise executing a selected number of times, (i)-(iv) and followed by (v)-(viii).

A twenty fourth aspect may include the features of the twenty third aspect, and may further comprise determining, from the resulting set of mass-to-charge ratios and the resulting set of charge magnitudes, a resulting set of masses of the generated charged particles.

A twenty fifth aspect may include the features of the twenty first aspect, and may further comprise completing each execution of (i)-(iv) and (v)-(viii) within a selected time period.

A twenty sixth aspect may include the features of any of the sixteenth through the twenty fifth aspects, and wherein controlling the AC voltage source comprises controlling the AC voltage source to change the frequency of the AC voltage, the method further comprising: selecting a base frequency of the AC voltage produced by the AC voltage source as a function of mass-to-charge ratios of the charged particles to be passed through the multi-pole charged particle transmission device, and selecting the first and second frequencies, wherein the second frequency is greater than the first frequency, such that the base frequency is between the first and second frequencies, such that the base frequency is the first frequency, or such that the base frequency is the second frequency.

A twenty seventh aspect may include the features of any of the sixteenth through the twenty fifth aspects, and wherein controlling the AC voltage source comprises controlling the AC voltage source to change the peak amplitude of the AC voltage, the method further comprising: selecting a base peak amplitude of the AC voltage produced by the AC voltage source as a function of mass-to-charge ratios of the charged particles to be passed through the multi-pole charged particle transmission device, and selecting the first and second amplitudes, wherein the second amplitude is greater than the first amplitude, such that the base peak amplitude is between the first and second amplitudes, such that the base peak amplitude is the first amplitude, or such that the base peak amplitude is the second amplitude.

A twenty eighth aspect may include the features of any of the sixteenth through the twenty seventh aspects, and wherein only the AC voltage is applied to the rods such that the multi-pole charged particle transmission device operates as a multi-pole charged particle guide.

A twenty ninth aspect may include the features of any of the sixteenth through the twenty seventh aspects, and may further comprise controlling a DC voltage source to also apply a DC voltage to the rods of the multi-pole charged particle transmission device such that the multi-pole charged particle transmission device operates as a multi-pole charged particle mass-to-charge ratio filter.

A thirtieth aspect may include the features of the twenty ninth aspect, and may further comprise selecting a magnitude of the DC voltage which defines a corresponding range of mass-to-charge ratios to pass through the multi-pole charged particle mass-to-charge ratio filter, and controlling the DC voltage source to apply the DC voltage with the selected magnitude to the rods of the multi-pole charged particle mass-to-charge ratio filter so as to pass through the multi-pole charged particle mass-to-charge ratio filter only charged particles having mass-to-charge ratios within the corresponding range of mass-to-charge ratios.

In a thirty first aspect, a charged particle analysis instrument may comprise a charge particle source configured to generate charged particles from a sample, a multi-pole charged particle transmission device having a charged particle inlet receiving the generated charged particles, the multi-pole charged particle transmission device having an even number of elongated rods spaced apart radially about a central axis extending axially through the device from the charged particle inlet at one end of the device to a charged particle outlet at an opposite end of the device, the multi-pole charged particle transmission device configured to transmit at least some of the generated charged particles therethrough, an AC voltage source operatively coupled to the rods of the multi-pole charged particle transmission device and configured to produce and apply an AC voltage to the rods, at least one charged particle analyzer having a charged particle inlet configured to receive charged particles after exiting the charged particle outlet of the multi-pole charged particle transmission device, at least one processor operatively coupled to the AC voltage source, and at least one memory device having instructions stored therein executable by the at least one processor to (i) control the AC voltage source to apply to the multi-pole charged particle transmission device the AC voltage having a frequency set to a first frequency, a peak amplitude set to a first amplitude and a waveform shape set to a first waveform shape, to pass a set of the generated charged particles through the charged particle transmission device, (ii) control the at least one charged particle analyzer to measure mass-to-charge ratios of the charged particles in the set of charged particles after exiting the charged particle outlet of the multi-pole charged particle transmission device, (iii) control the AC voltage source to change one of the frequency of the AC voltage to a second frequency different from the first frequency, the peak amplitude of the AC voltage to a second amplitude different from the first amplitude, or the waveform shape of the AC voltage to a second waveform shape different from the first waveform shape, to pass another set of the charged particles through the charged particle transmission device, (iv) control the at least one charged particle analyzer to measure mass-to-charge ratios of the charged particles in the another set of charged particles exiting the charged particle outlet of the multi-pole charged particle transmission device, and (v) average the measured mass-to-charge ratios of the charged particles in the set and the another set of charged particles to produce a resulting set of mass-to-charge ratios of the generated charged particles.

A thirty second aspect may include the features of the thirty first aspect, and wherein the instructions stored in the memory may further include instructions executable by the at least one processor to control the at least one charged particle analyzer to measure charge magnitudes of the charged particles in the set of charged particles exiting the charged particle outlet of the multi-pole charged particle transmission device, control the at least one charged particle analyzer to measure charge magnitudes of the charged particles in the another set of charged particles exiting the charged particle outlet of the multi-pole charged particle transmission device, and average the measured charge magnitudes of the charged particles in the set and the another set of charged particles to produce a resulting set of charge magnitudes of the generated charged particles.

A thirty third aspect may include the features of the thirty second aspect, and wherein the instructions stored in the memory may further include instructions executable by the at least one processor to determine, from the resulting set of mass-to-charge ratios and the resulting set of charge magnitudes, a resulting set of masses of the generated charged particles.

In a thirty fourth aspect, a multi-pole charged particle transmission instrument may comprise a multi-pole charged particle transmission device having a charged particle inlet configured to receive charged particles, the multi-pole charged particle transmission device having an even number of elongated rods spaced apart radially about a central axis extending axially through the device from the charged particle inlet at one end of the device to a charged particle outlet at an opposite end of the device, the multi-pole charged particle transmission device configured to transmit at least some of the generated charged particles therethrough, an AC voltage source operatively coupled to the rods of the multi-pole charged particle transmission device and configured to produce and apply an AC voltage to the rods, at least one processor, and at least one memory device having instructions stored therein executable by the at least one processor to (i) control the AC voltage source to apply to the multi-pole charged particle transmission device the AC voltage having a frequency set to a first frequency, a peak amplitude set to a first amplitude, and a waveform shape set to a first waveform shape, to pass a set of charged particles through the charged particle transmission device, and (ii) control the AC voltage source to change one of the frequency of the AC voltage to a second frequency different from the first frequency, the peak amplitude of the AC voltage to a second amplitude different from the first amplitude, or the waveform shape of the AC voltage to a second waveform shape different from the first waveform shape, to pass another set of the charged particles through the charged particle transmission device.

A thirty fifth aspect may include the features of the thirty fourth aspect, and wherein the instructions stored in the at least one memory may further include instructions executable by the at least one processor to, prior to controlling the AC source to change the one of the frequency of the AC voltage to the second frequency, or the peak amplitude of the AC voltage to the second amplitude, (iii) control the AC voltage source to advance the one of the frequency of the applied AC voltage by a first selected step size toward the second frequency, or the peak amplitude of the applied AC voltage by the first selected step size toward the second amplitude, to pass a new set of the charged particles through the charged particle transmission device, and (iv) execute (iii) until the one of the advanced frequency reaches the second frequency, or the advanced amplitude reaches the second amplitude.

A thirty sixth aspect may include the features of the thirty fifth aspect, and wherein the instructions stored in the at least one memory may further include instructions executable by the at least one processor to, after the one of the advanced frequency reaches the second frequency, or the advanced amplitude reaches the second amplitude, (v) control the AC voltage source to advance the one of the frequency of the applied AC voltage by a second selected step size back toward the first frequency, or the peak amplitude of the applied AC voltage by the second selected step size back toward the first amplitude, to pass another new set of the charged particles through the charged particle transmission device, and (vi) execute (v) until the advanced frequency reaches the first frequency.

A thirty seventh aspect may include the features of the thirty sixth aspect, and wherein the instructions stored in the at least one memory may further include instructions executable by the at least one processor to execute a selected number of times, (iii)-(iv) and followed by (v)-(vi).

### BRIEF DESCRIPTION OF THE DRAWINGS

FIG. 1 is a simplified diagram of a charged particle analysis instrument or system including a multi-pole device operating as a charged particle guide or mass-to-charge filter.

FIG. 2 is a simplified perspective view of an embodiment of the multi-pole device of FIG. 1 in the form of a quadrupole device configured to be operably controlled by a time-varying voltage source or, optionally, by the combination of an AC voltage source and a DC voltage source.

FIG. 3 is a cross-sectional view of the multi-pole device of FIGS. 1 and 2, as viewed along section lines 3-3 of FIG. 1, illustrating angular deviation within and at the outlet of the device of two sets of charged particles each having the same mass but a different number of charges, with the multi-pole device controlled by a single-frequency time-varying voltage source.

FIG. 4 is a plot of angular deviation at the outlet of the multi-pole device of FIG. 2 of charged particles with the same masses but having a range of different numbers of charges, with the multi-pole device controlled by a single-frequency time-varying voltage source.

FIG. 5 is a simplified flowchart of an embodiment of a method for controlling the multi-pole device of FIGS. 1 and 2 so as to avoid, or at least reduce, the effects of angular deviation of charged particles exiting the outlet thereof.

FIG. 6 is a plot of frequency vs. time of the AC output voltage of the voltage source V2 of FIGS. 1 and 2, illustrating an example implementation of the process illustrated in FIG. 5.

FIG. 7A is a plot of a mass-to-charge ratio spectrum of an example set of charged particles passed through the multi-pole instrument of FIGS. 1 and 2, with the time-varying voltage source of the multi-pole device controlled to produce an AC voltage at a single-frequency.

FIG. 7B is a plot of a mass-to-charge ratio spectrum of the same example set of charge particles of FIG. 7A passed through the multi-pole instrument of FIGS. 1 and 2, but with the time-varying voltage source of the multi-pole device controlled to sweep the AC voltage through a range of frequencies according to the method illustrated by example in FIG. 5.

FIG. 8A is a plot of a mass and charge of the same example set of charged particles as FIGS. 7A and 7B passed through the multi-pole instrument of FIGS. 1 and 2, with the time-varying voltage source of the multi-pole device controlled to produce the AC voltage with the same single-frequency as FIG. 7A.

FIG. 8B is a plot of a mass-to-charge ratio spectrum of the same example set of charge particles of FIGS. 7A-8A passed through the multi-pole instrument of FIGS. 1 and 2, but with the time-varying voltage source of the multi-pole device controlled to sweep the AC voltage through the same range of frequencies as FIG. 7B according to the method illustrated by example in FIG. 5.

FIG. 9 is a simplified flowchart of another embodiment of a method for controlling the multi-pole device of FIGS. 1 and 2 so as to avoid, or at least reduce, the effects of angular deviation of charged particles exiting the outlet thereof.

FIG. 10A is a plot of a mass-to-charge ratio spectrum of an example set of charged particles passed through the multi-pole instrument of FIGS. 1 and 2, with the time-varying voltage source of the multi-pole device controlled to produce an AC voltage at a single-frequency and a single peak amplitude.

FIG. 10B is a plot of a mass-to-charge ratio spectrum of the same example set of charge particles of FIG. 10A passed through the multi-pole instrument of FIGS. 1 and 2, but with the time-varying voltage source of the multi-pole device controlled to sweep the AC voltage through a range of peak amplitudes according to the method illustrated by example in FIG. 9.

FIG. 11A is a plot of a mass and charge of the same example set of charged particles as FIGS. 10A and 10B passed through the multi-pole instrument of FIGS. 1 and 2, with the time-varying voltage source of the multi-pole device controlled to produce the AC voltage with the same single-frequency and same peak amplitude as FIG. 10A.

FIG. 11B is a plot of a mass-to-charge ratio spectrum of the same example set of charge particles of FIGS. 10A-11A passed through the multi-pole instrument of FIGS. 1 and 2, but with the time-varying voltage source of the multi-pole device controlled to sweep the AC voltage through the same range of peak amplitudes as FIG. 10B according to the method illustrated by example in FIG. 9.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

This disclosure relates to one or more methods for controlling, e.g., in a charged particle analysis instrument or system, a multi-pole device in a manner which prevents, or at least reduces, inadvertent omission of charged particles exiting the multi-pole device from analysis by one or more downstream components of the charged particle analysis instrument or system.

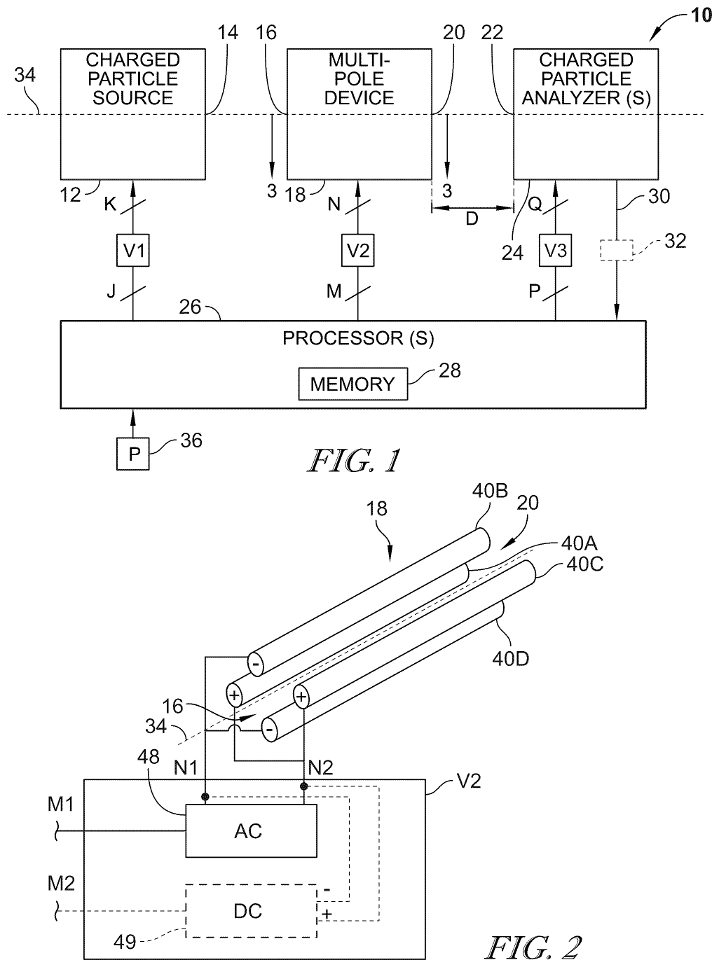

Referring now to FIG. 1, an embodiment of a charged particle analysis instrument or system 10 is shown. In the illustrated embodiment, the system 10 includes a charged particle source 12 having a charged particle outlet 14, a multi-pole charged particle transmission device 18 having a charged particle inlet 16, configured to receive charged particles exiting the charged particle outlet 14 of the charged particle source 12, and a charged particle outlet 20, and at least one charged particle analyzer 24 having a charged particle inlet 22 configured to receive charged particles exiting the charged particle outlet 20 of the multi-pole charged particle transmission device 18. Although not shown in FIG. 1, it will be understood that the charged particle analyzer(s) 24 may include at the charged particle inlet 22 one or more charged particle processing instruments and/or stages, configured to process charged particles, e.g., to focus or steer charged particles and/or to select one or more subsets of charged particles, prior to charged particle analysis as described below.

The instrument or system 10 further illustratively includes a number of voltage sources, e.g., V1-V3, each operatively coupled between at least one processor 26 and a respective one of the charged particle source 12, the multi-pole device 18 and the charged particle analyzer(s) 24. The at least one processor 26 may be conventional and include a single processor or multiple processors, wherein the term “processor” means, for purposes of this document, a decision-making circuit configured to be programmed and/or manually controlled to control operation of the voltage sources. In some embodiments, the decision-making circuit may be or include a conventional microprocessor or microcontroller and a memory unit 28 having instructions stored therein which are executable by the microprocessor or microcontroller to control operation of the voltage sources. In alternate embodiments, the decision making circuit may be or include application-specific digital and/or analog circuitry designed or otherwise configured to control operation of the voltage sources. In some embodiments, one or more conventional peripheral devices 36 may be operatively coupled to the processor(s) 26. Examples of such one or more peripheral devices may include, but are not limited to, one or more information entry devices such as a keyboard, keypad, point-and-click device, microphone or the like, one or more information output devices such as a printer, display monitor or the like, and/or one or more data and/or instruction storage devices.

In the illustrated embodiment a number, J, of signal inputs of the voltage source V1 are electrically connected to corresponding signal outputs of the processor 26, and a number, K, of voltage outputs of V1 are electrically connected to respective voltage inputs of the charged particle source 12, where J and K may each by any positive integer. The voltage source V1 may include any number of DC and/or AC (i.e., time and amplitude variable) sources controllable by the processor 26 to apply respective voltages to the charged particle source 12 for control of the charged particle 12 by the processor 26 to produce charged particles. A number, M, of signal inputs of the voltage source V2 are electrically connected to corresponding signal outputs of the processor 26, and a number, N, of voltage outputs of V2 are electrically connected to respective voltage inputs of the multi-pole charged particle transmission device 18, where M and N may each by any positive integer. The voltage source V2 may include any number of DC and/or AC (i.e., time and amplitude variable) sources controllable by the processor 26 to apply respective voltages to the multi-pole charged particle transmission device 18 for control of the multi-pole charged particle transmission device 18 by the processor 26 to guide, or filter and guide, charged particles generated by the charged particle source 12 into the charged particle analyzer(s) 24. A number, P, of signal inputs of the voltage source V3 are electrically connected to corresponding signal outputs of the processor 26, and a number, Q, of voltage outputs of V3 are electrically connected to respective voltage inputs of the charged particle analyzer(s) 24, where P and Q may each by any positive integer. The voltage source V3 may include any number of DC and/or AC (i.e., time and amplitude variable) sources controllable by the processor 26 to apply respective voltages to the charged particle analyzer(s) 24 for control of the charged particle analyzer(s) 24 by the processor 26 to process the charged particles transmitted thereto by the multi-pole charged particle transmission device 18.

In some embodiments of the instrument or system 10, the charged particle analyzer(s) 24 may include at least one charged particle detector 32 as illustrated in FIG. 1 by dashed-line representation. In some such embodiments, the at least one charged particle detector 32 may include at least one charged particle detector having an input electrically coupled to the charged particle analyzer(s) 24 via at least one signal path 30, and/or the at least one charged particle detector 32 may include at least one charged particle detector positioned relative to the charged particle analyzer(s) 24 so as to detect arrival of charged particles thereat. In the former case, the charged particle detector(s) 32 may be or include, for example, but should not be limited to, one or more conventional charge sensitive preamplifiers, and in the latter case the charged particle detector(s) 32 may be or include, for example, but should not be limited to, a conventional microchannel plate detector or equivalent thereof. In any case, in embodiments which include at least one charged particle detector 32, at least one signal output of the at least one charged particle detector 32 is electrically coupled to at least one respective input of the at least one processor 26. The processor 26 is illustratively configured, e.g., via execution of instructions stored in the memory 28, to process charge detection signals produced by the at least one charged particle detector 32 to determine one or more charged particle characteristics and, in some embodiments, to produce for graphical display and/or analysis at least one spectrum including the determined one or more charged particle characteristics.

As depicted by example in FIG. 1, the stages 12, 18, 24 are illustratively aligned with one another such that a central, longitudinal axis 34 extends through each respective charged particle inlet and outlet in the instrument or system 10 via and about which the charged particles travel in and through the various stages of the instrument or system 12, although it will be understood that in alternate embodiments one or more of the stages 12, 18, 24 may not be so aligned with others of the stages 12, 18, 24 but in such embodiments one or more conventional charged particle guiding or steering devices may be used to direct charged particles exiting a stage 12, 18 to enter the charged particle inlet 16, 22 of the next stage 18, 24. In the illustrated embodiment, the charged particle outlet 20 of the multi-pole device 18 is spaced apart by a distance D from the charged particle inlet 22 of the charged particle analyzer 24 or from the charged particle inlet 22 of a first charged particle processing stage of a multi-stage embodiment of the charged particle analyzer 24.

The charged particle source 12 may illustratively include any conventional device or apparatus for generating charged particles (i.e., ions) from a sample. As one illustrative example, which should not be considered to be limiting in any way, the charged particle source 12 may be or include a conventional electrospray ionization source, a matrix-assisted laser desorption ionization (MALDI) source or other conventional instrument or device configured to generate charged particles from a sample in solution, gas or solid form. The sample from which the ions are generated may be or include any biological and/or other material. In some embodiments, the charged particle source 12 may further include one or more devices and/or instruments for separating, collecting, filtering, fragmenting, and/or normalizing or shifting charge states of charged particles according to one or more molecular characteristics. As one example of such an additional device or instrument that may be included in, or as part of, the charged particle source 12, a mass spectrometer may be implemented to separate the generated charged particles according to mass-to-charge ratio prior to exit from the charged particle exit 14 of the charged particle source 12. Such a mass spectrometer may be of any conventional design including, for example, but not limited to a time-of-flight (TOF) mass spectrometer, a reflectron mass spectrometer, a Fourier transform ion cyclotron resonance (FTICR) mass spectrometer, a quadrupole mass spectrometer, a triple quadrupole mass spectrometer, a magnetic sector mass spectrometer, or the like.

The charged particle analyzer(s) 24 may illustratively include any conventional device or sequential combination of conventional devices configured to separate, collect, filter, fragment and/or normalize or shift charge states of charged particles according to one or more molecular characteristics and/or to measure one or more molecular characteristics and/or charge characteristics of charged particles. In one example embodiment, the charged particle analyzer(s) 24 may include at least one conventional mass spectrometer or mass analyzer configured to separate and detect charged particles according to mass-to-charge ratio. Alternatively or additionally, the charged particle analysis device(s) 24 may include at least one mobility device configured to separate and detect charged particles according to ion mobility. Alternatively or additionally, the charged particle analysis device(s) 24 may include at least one electrostatic linear ion trap (ELIT) and/or orbitrap configured to simultaneously measure mass-to-charge ratios and charge magnitudes of charged particles (from which charged particle mass can be directly determined). In such embodiments, the at least one charged particle detector 32 may be or include one or more charge detection amplifiers and/or charge sensitive preamplifiers as briefly described above. Those skilled in the art will recognize other examples of conventional devices or instruments that may be or be included in the charged particle analyzer(s) 24, and it will be understood that such other examples are intended to fall within the scope of this disclosure. It will be further understood that none of the foregoing examples should be considered to be limiting in any way.

In embodiments in which the voltage source V2 includes only an AC voltage source (or in which only an AC voltage source of the voltage source V2 is activated), the multi-pole charged particle transmission device 18 will operate to guide charged particles between the charged particle source 12 and the charged particle analyzer(s) 24 (i.e., such that the multi-pole charged particle transmission device 18 operates as a multi-pole charged particle guide). In embodiments in which the voltage source V2 includes and AC voltage source and a DC voltage source, wherein both such sources are activated, multi-pole charged particle transmission device 18 will be configured to receive charged particles generated by the charged particle source 12, filter the received charged particles based on mass-to-charge ratio of the received charged particles (as determined in a conventional manner by the magnitude of the DC voltage), and transmit to the charged particle analyzer(s) 24 a subset of the received charged particles having mass-to-charge ratios within a specified range of mass-to-charge ratios determined by the magnitude of the DC voltage applied by the DC voltage source (i.e., such that the multi-pole charged particle transmission device 18 operates as a multi-pole charged particle mass-to-charge filter). In any case, the multi-pole charged particle transmission device 18 may have any even number of poles, typically in the form of elongated rods. A typical multi-pole charged particle transmission device 18 may include 4 poles, 6 poles or 8 poles, although multi-pole charged particle transmission devices 18 with a greater even number of poles may alternatively be used. In the case of 4 poles or rods the multi-pole charged particle transmission device 18 is typically referred to as a quadrupole device, in the case of 6 poles or rods the multi-pole charged particle transmission device 18 is typically referred to as a hexapole device, and in the case of 8 poles or rods the multi-pole charged particle transmission device 18 is typically referred to as an octopole device. The poles, e.g., elongated rods, may have any cross-sectional shape or profile, with common examples being circular, square or rectangular, and hyperbolic.

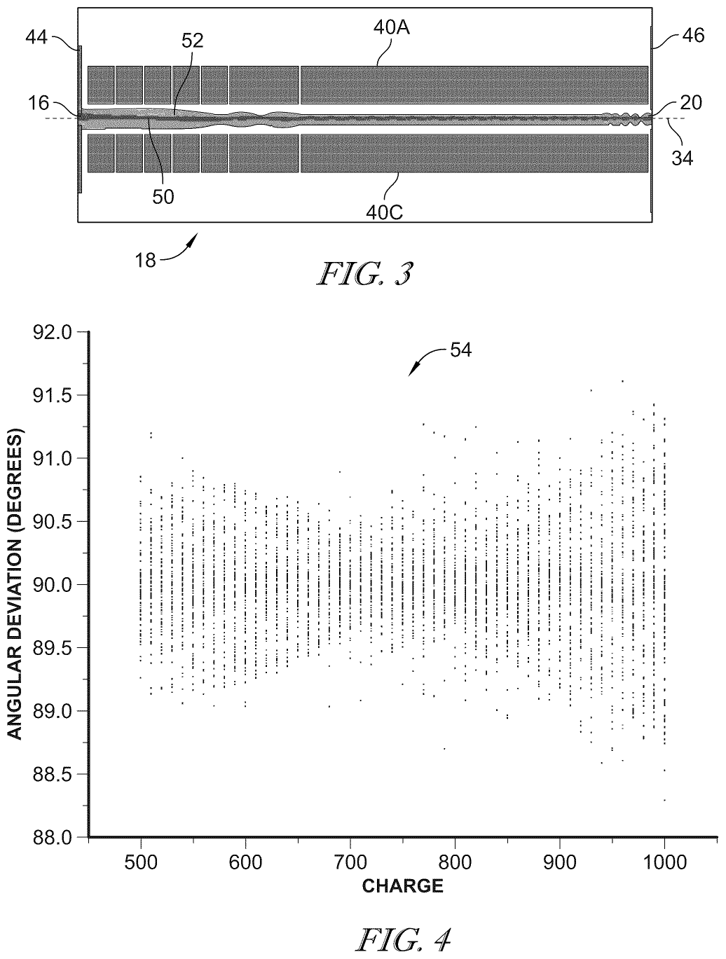

Referring now to FIG. 2, an example embodiment is shown of the multi-pole charged particle transmission device 18 implemented in the form of a conventional quadrupole charged particle guide or mass-to-charge filter 18. In the illustrated embodiment, the quadrupole device 18 illustratively includes four elongated, electrically conductive rods 40A, 40B, 40C and 40D disposed parallel with one another and arranged concentrically about, and radially spaced from, the central, longitudinal axis 34 such that the charged particle inlet 16 is defined at one axial end of the rods 40A-40D and the charged particle outlet 20 is defined at an opposite axial end of the rods 40A-40D. Charged particles thus enter the charged particle inlet 16 and travel axially through the quadrupole device 18 and exit through the charged particle outlet 20. In some embodiments, as illustrated by example in FIG. 3, the charged particle inlet 16 may be defined by an opening defined through an inlet plate or grid 44, and the charged particle outlet 20 may be defined by an opening defined through an outlet plate or grid 46. The rods 40A, 40B, 40C and 40D are illustrated by example in FIG. 2 as being generally circular in cross-section, although it will be understood that the rods 40A-40D may alternatively have any desired cross-sectional shape or profile, some non-limiting examples of which are described above.

An embodiment is also shown in FIG. 2 of the voltage source V2. In the illustrated embodiment, the voltage source V2 includes an AC voltage source 48 having an input, M1, coupled to a respective output of the processor 26, one output, N1, electrically coupled to two opposed rods 40B, 40D and another output, N2, electrically coupled to the remaining two opposed rods 40A, 40C. In the general case of a multi-pole charged particle transmission device 18 having any even number of poles or rods, the N1 and N2 outputs of the AC voltage source 48 (and of the voltage source V2) will be connected to the various poles or rods in radially alternating fashion, i.e., such that the voltage outputs are connected N1, N2, N1, N2, etc. radially about the device 18.

In some embodiments, the AC source 48 is configured to produce a periodic AC voltage in the radio frequency (RF) range, although in alternate embodiments the AC source 48 may be configured to alternatively or additionally produce AC voltages in frequency ranges outside of the RF range. In any case, the AC voltage source 48 is illustratively configured to be controlled by the processor 26, by one or more processors integrated into the AC voltage source 48, and/or controlled manually, to produce the AC voltage at any desired frequency within its allowable or programmed frequency range and with any desired shape, at any desired peak amplitude within its allowable or programed amplitude range, and with any desired duty cycle. Example waveform shapes may include, but are not limited to, sine wave, square wave, triangular wave, sawtooth wave (e.g., in which the hypotenuse of each sawtooth triangle represents the rising edge of the sawtooth pulse), reverse sawtooth wave (e.g., in which the hypotenuse of each sawtooth wave represents the falling edge of the sawtooth pulse), or the like, although it will be understood that the waveform shape of the AC voltage produced by the AC source 48 may have other shapes. Examples of such other shapes may include, for example, but are not limited to waveforms shapes obtained by combining two or more of any one or combination the above example waveform shapes, waveform shapes obtained by selecting specific combinations of the fundamental frequency and/or the various harmonic frequencies of the frequency domain representation (e.g., a Fourier series representation) of a base AC voltage produced by the AC source 48, and/or arbitrary waveform shapes obtained by programming various waypoints of the AC source 48 provided in the form of a conventional arbitrary waveform generator (AWG).

In some embodiments, as illustrated by dashed-line representation in FIG. 2, the voltage source V2 may further include a DC voltage source 49 having an input, M2, coupled to a respective output of the processor 26, one output electrically coupled to the two opposed rods 40A, 40C and another output electrically coupled to the remaining two opposed rods 40B, 40D, e.g., such that the positive terminal + of the DC voltage source 49 is connected to the N2 output of the AC voltage source 48 and the negative or ground terminal − of the DC voltage source 49 is connected to the N1 output of the AC voltage source 48. In embodiments that include it, the DC voltage source 49 is illustratively configured to be controlled by the processor 26, by one or more processors integrated into the DC voltage source 49, and/or controlled manually, to produce the DC voltage at any desired amplitude within its allowable or programed amplitude range.

In embodiments of the voltage source V2 that do not include the DC voltage source 49, the resulting device 18 is typically referred to as an “RF-only multi-pole guide” and is operable, with an applied RF (AC) voltage, as a multi-pole charged particle guide which guides charged particles through the device 18 along and about the central axis 34, as will be described in greater detail with respect to FIGS. 3 and 4. In embodiments which include the DC voltage source 49, the resulting device 18 is typically referred to as a “multi-pole mass-to-charge filter,” or in a shortened version as a “multi-pole mass filter,” which is operable in any case, with an applied RF (AC) voltage and an applied DC voltage, to guide through the device only a subset of the charged particles having mass-to-charge ratios within a selected range of mass-to-charge ratios, wherein the selected range of mass-to-charge ratios of the charged particles that may exit the device 18 is defined by the magnitude of the DC voltage produced by the DC voltage source 49. Charged particles having mass-to-charge ratios outside of this range are neutralized on and by the rods 40A-40D. In embodiments in which the multi-pole charged particle transmission device 18 includes four rods as illustrated by example in FIG. 2, the former device 18 is typically referred to as an “RF-only quadrupole guide” and the latter device is typically referred to as a “quadrupole mass-to-charge filter,” or a “quadrupole mass filter.”

It will be understood that the instrument or system 10 illustrated in FIG. 1 and just described may include one or more additional charged particle processing components or stages prior to the charged particle source 12, between the charged particle source 12 and the multi-pole charged particle transmission device 18, between the multi-pole charged particle transmission device 18 and the charged particle analyzer(s) 24, between at least two stages or instruments of a charged particle analyzer having multiple stages or instruments and/or following the charged particle analyzer(s) 24. It will be further understood that the instrument or system 10 may alternatively or additionally include any number of multi-pole charged particle transmission device 18 prior to, between, part of or following any of the stages 12, 18, 24, wherein such multi-pole charged particle transmission devices 18 may be controlled as described below.

Referring now to FIG. 3, a cross-sectional view is shown of the quadrupole device 18 of FIG. 2, wherein the quadrupole device 18 is configured as an RF-only quadrupole charged particle guide (i.e., such that the voltage source V2 includes only the AC source 48 configured or programmed to produce an AC voltage in the radio frequency range). In the operation of the RF-only quadrupole guide 18, a potential well U(r), which focuses charged particles centrally within the RF only quadrupole guide 18, i.e., toward and about the central axis 34, can be represented using the equation:

$$U ( r ) = \frac{{n}^{2} {z}^{2} {e}^{2} {V}^{2}}{( 4 {mr}_{o}^{2} {ω}^{2} ) {( r / {r}_{o} )}^{2 n - 2}}$$

In this equation, n represents the number of pairs of rods (e.g., n=2 in the device 18 illustrated in FIGS. 2 and 3), z is the number of charges, e is the charge of an electron in coulombs, V is the peak amplitude of the applied RF voltage, m is the mass of the charged particle, r is the distance of the charged particle from the central axis 35, rₒ is the inscribed radius of the quadrupole device 18 and ω is the angular frequency. From this equation, it can be seen that as the peak amplitude, V, of the RF voltage increases, charged particles with higher m/z values can be focused to the center axis 34, but the low m/z cutoff is raised. Charged particles below the low mass-to-charge ratio (m/z) cutoff are lost due to resonance with the RF component, while charged particles with m/z values above a high m/z threshold are unable to be effectively focused.

Ideally, within the aforementioned range of m/z values between the low m/z cutoff and the high m/z threshold, the transmission efficiency for charged particles passing through the RF-only quadrupole 18 of FIGS. 2 and 3; that is, the ratio of the number of charged particles transmitted through the RF-only quadrupole 18 and the number of charged particles entering the RF-only quadrupole 18, should be independent of the mass-to-charge ratio m/z of the charged particles. While this is largely true, the trajectories of charged particles exiting the quadrupole 18 is m/z dependent, and the differences in such trajectories may adversely affect the transmission efficiency of the charged particles from the quadrupole 18 to the charged particle analyzer(s) 24; that is, the ratio of the number of charged particles exiting the charged particle outlet 20 of the RF-only quadrupole 18 and the number of charged particles entering the charged particle inlet 22 of the charged particle analyzer(s) 24. Due to similarity in behavior for charged particles of the same m/z, certain m/z ranges or bands of charged particles are transmitted less effectively than others, potentially resulting in the loss of charged particles in such m/z ranges or bands between the quadrupole 18 and the charged particle analyzer(s) 24, thereby resulting in artifacts in spectra acquired in and by the charged particle analyzer(s) 24. Moreover, the likelihood and severity of such trajectory-related loss of charged particles between the charged particle outlet 20 of the quadrupole 18 and the charged particle inlet of the charged particle analyzer(s) 24 increases with the distance, D, between the charged particle outlet 20 of the quadrupole 18 and the charged particle input 22 of the charged particle analyzer(s) 24 (see, e.g., FIG. 1).

Charged particles axially traverse the quadrupole 18, i.e., entering the charged particle inlet 16 and exiting the charged particle outlet 20, while also oscillating in the radial direction about the central, longitudinal axis 34 as a result of the time-varying nature of the AC voltage applied to the quadrupole 18 by the voltage source V2. In embodiments in which the applied AC voltage is, for example, a sinusoidal RF voltage, charged particles move in a sinusoidal pattern in the radial direction about the central, longitudinal axis 34 as the charged particles travel axially along the quadrupole 18 from the charged particle inlet 16 toward, and through, the charged particle outlet 20. In any case, as a result of such RF confinement, charged particles may exit the charged particle outlet 20 at a so-called “node,” defined at and by the central, longitudinal axis 34, at a so-called “anti-node,” defined as the furthest radial distance from the central, longitudinal axis 34, i.e., defined by the terminal wall(s) or edge(s) of the opening of the charged particle outlet 20 through which charged particles exit the quadrupole 18, which is a function of at least one parameter of the applied RF voltage, and at any point between the node and the anti-node. This phenomenon is referred to as “noding,” and results in angular deviation from the central, longitudinal axis 34 of at least some of the charged particles exiting the charged particle outlet 20 of the quadrupole 18 and as the charged particles move away from the charged particle outlet 20.

In the example quadrupole 18 of FIG. 3, trajectories are shown for 2.7 MDa charged particles with two different charges with the RF voltage produced by the voltage source V2 in the form of a sinusoidal waveform. The charged particles 50, for example (darker pattern in FIG. 3), have 750 charges and the charged particles 52 (lighter pattern in FIG. 3) have 500 charges. As depicted by example, in FIG. 3, the charged particles 50 (with 750 charges) are more tightly focused on and about the central axis 34, whereas the charged particles 52 are less so and exit the charged particle outlet 20 at a radial distance between the node and the anti-node, thereby causing the charged particles 52 to disperse angularly away from the central axis 34 as the charged particles 52 exit the quadrupole and continue toward the charged particle analyzer(s) 24. The angular deviance of the charged particles 52 at the charged particle outlet 20 of the quadrupole 18, as illustrated by example in FIG. 3, is exacerbated by the distance, D, between the charged particle outlet 20 of the quadrupole 18 and the charged particle input 22 of the charged particle analyzer(s) 24 (see, e.g., FIG. 1), and as a result the charged particles 52 reaching the charged particle analyzer(s) 24 may be too widely dispersed to enter the charged particle inlet 22 of the charged particle analyzer(s) 24. Thus, whereas most or all of the charged particles 50, tightly focused about the central, longitudinal axis 34, will travel the distance, D, and enter the charged particle inlet 22 of the charged particle analyzer(s) 24, some or all of the charged particles 52, exiting the charged particle outlet 16 of the quadrupole 20 at a radial distance between the node and the anti-node, may not.

As charged particles of the same m/z behave similarly, some or all of the charged particles of other sub-populations, i.e., those having the same, or nearly the same, m/z as the charged particles 52, likewise may not be transmitted into the charged particle inlet 22 of the charged particle analyzer(s) 24. Referring to FIG. 4, for example, a plot 54 is shown of angular divergence of charged particles at the charged particle outlet 20 of the quadrupole 18 vs charge state of the 2.7 MDa charged particles illustrated by example in FIG. 3. The plot 54 illustrates the angular divergence of 50 charged particles for every 10 charge states between 500 and 1000 charges. Each charged particles possesses the same mass, 2.7 MDa in this example, and the difference in charge states thus results in correspondingly different m/z values. The different charge states illustrated in FIG. 4 have noticeably different levels of focusing, with charged particles having approximately 750 charges being the most focused and charged particles having approximately 1000 charges being the most angularly dispersed. Thus, due to the effects of noding as described above, it should be expected that, in the instrument or system 10 illustrated in FIG. 1, at least some of the charged particles at or near the extreme charge states shown in FIG. 4 will not be transmitted into the charged particle analyzer(s) 24, whereas most, if not all, of the charged particles near the center of the charge states shown in FIG. 4 will be transmitted into the charged particle analyzer(s) 24.

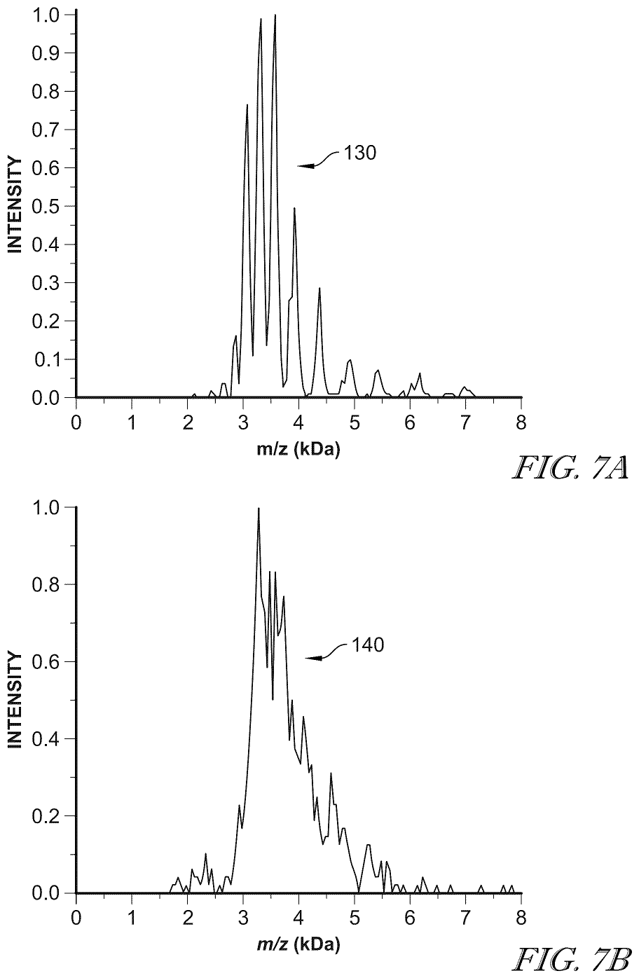

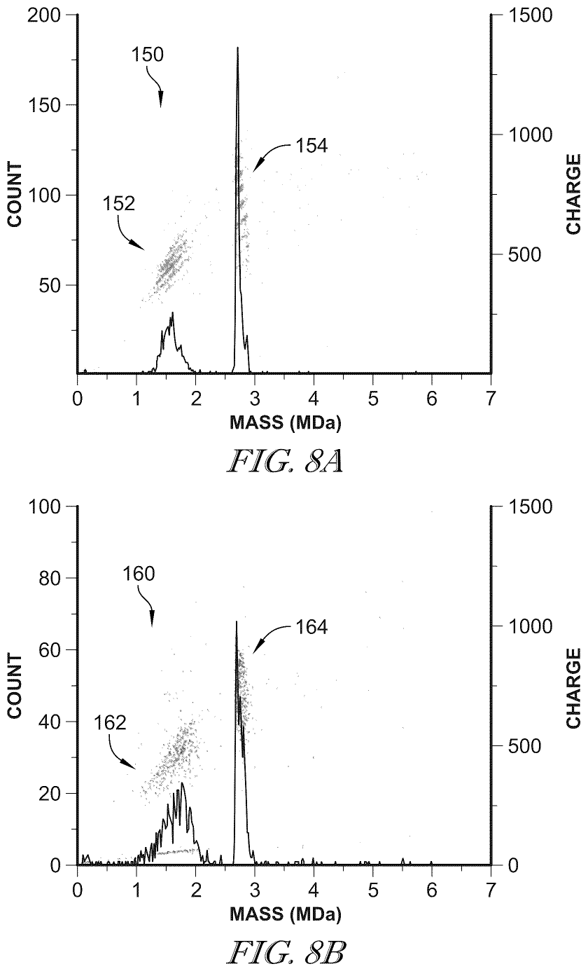

Use of an RF only quadrupole 18, such as that illustrated by example in FIGS. 2 and 3, in an instrument or system, such as the instrument or system 10 illustrated by example in FIG. 1, typically involves determining a voltage gradient and a frequency, e.g., RF sinusoidal, which maximizes transmission of charged particles of interest, e.g., charged particles within a selected range of mass and/or mass-to-charge ratios, and then holding these settings constant for the duration of operation of the instrument or system 10 to produce a spectrum of the sample. This conventional technique generally works well when analyzing charged particles within small to medium sized m/z ranges, but may fail when analyzing charged particles in larger m/z ranges due to the noding effect described above. Referring to FIGS. 7A and 8A, for example, a m/z spectrum 130 (FIG. 7A) and a mass and charge scatter plot (mass and charged distributions overlaid onto one another) spectrum 150 (FIG. 8A) are shown in which the instrument 10 of FIG. 1 was used, with the quadrupole 18 operated as an RF-only quadrupole driven by a sinusoidal RF voltage source V2 at a frequency of approximately 450 kHz, to analyze a sample of plasmid pBR322 vector having a known mass of approximately 2.83 MDa. Each of the plots 130, 150 demonstrate the effects of quadrupole noding, as defined and described above. As depicted in FIG. 8A, for example, the effect of noding in the quadrupole 18 is visible in the form of two sets 152, 154 of several distinct streaks of points, with the first set 152 extending between approximately 1.3-2 MDa, and with the second set 154, extending between approximately 2.6-2.9 MDa. The several distinct streaks of points depicted in FIG. 8A, despite appearing to represent distinct sub-populations of charged particles, are due to the unintended m/z selection in the RF-only quadrupole 18. Each streak of points within each set 152, 154, illustratively represents a different sub-population of charged particles within a different respective m/z range, and the blank areas between adjacent streaks of points within each set 152, 154 represent failure of the quadrupole 18 to effectively transmit charged particles within the respective m/z ranges to the charged particle inlet 22 of the charged particle analyzer(s) 24. Due to the extremely large spread of charges possible for the pBR322 vector, the noding effect is especially pronounced in FIG. 8A, and is further corroborated by the multitude of different peaks observed in the m/z plot 130 of FIG. 7A.

The noding effect of the quadrupole 18, and of any multi-pole device described above, has been found to be dependent upon the frequency of the AC voltage produced by the AC source 48 of the voltage source V2 described above. That is, the point of exit of a charged particle having a particular m/z from the charged particle outlet 20 of the quadrupole 18, relative to the central, longitudinal axis 34, is a function of the frequency of the AC voltage produce by the AC source 48. Thus, with the AC source 48 implemented as a sinusoidal RF source, for example, charged particles having mass-to-charge ratios m/z may exit the charged particle outlet 20 of the quadrupole 18 at the node of the quadrupole 18, i.e., at and along the central, longitudinal axis 34, at an RF frequency F1, but may exit the charged particle outlet 20 of the quadrupole 18 at an anti-node, as this term is defined above, at a different RF frequency F2, and may exit the charged particle outlet 20 of the quadrupole 18 at any point between the node and any anti-node defined radially about the node 34 at RF frequencies other than F1 or F2. This phenomenon can illustratively be exploited to eliminate, or at least greatly reduce, the noding effect by operating the AC voltage source 48 of the quadrupole 18 to produce the AC voltage at different frequencies to shift the corresponding m/z-dependent exit trajectories of charged particles from the charged particle outlet 20 of the quadrupole 18 between and along the node 34 and anti-node(s), and then averaging the charged particle detection data acquired by the downstream charged particle analyzer(s) 24. This technique will illustratively distribute the losses in charged particle transmission efficiencies between the quadrupole 18 and the charged particle analyzer(s) 24, depicted by example in FIGS. 7A and 8A and as described above, across all m/z populations, thereby resulting in a more uniform detection of charged particles across the m/z range of interest and thereby eliminating, or at least greatly reducing, extraneous peaks observed in m/z spectrums, e.g., like the m/z plot 130 of FIG. 7A described above, as well as distinct streaks of points in mass and charge scatter plot spectrums, e.g., like the mass and charge scatter plot 150 of FIG. 8A.

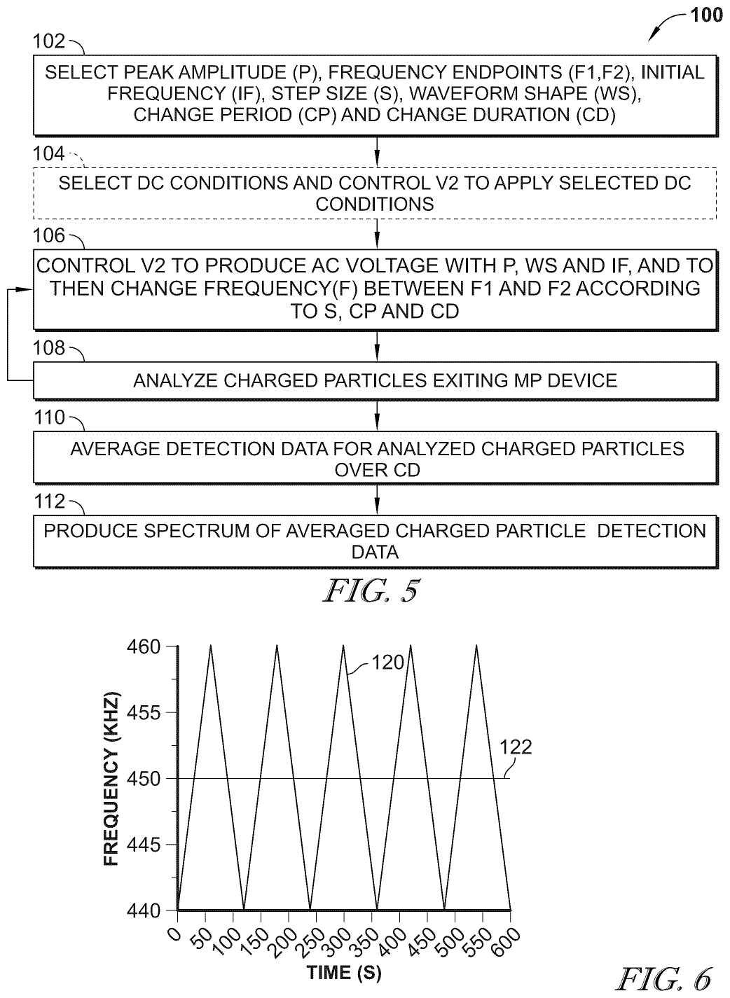

Referring now to FIG. 5, a flowchart is shown of an example process 100 for operating the AC source 48 of the voltage source V2 at different frequencies to eliminate, or at least reduce, the noding effect of any multi-pole device 18 on subsequently acquired charged particle measurement data. In one embodiment, the process 100 is implemented in the form of instructions stored in the memory device 28 and executable by the processor(s) 26 to control the voltage source V2 of FIG. 1 as will be described below. In some alternative embodiments, the process 100 may be implemented, in whole or in part, by one or more other processors and/or by circuitry on-board the voltage source V2. In some alternative embodiments, the process 100 may be implemented, in whole or in part, by hardware forming at least part of the processor(s) 26 and/or by off-board circuitry. In any case, the process 100 will be described as being stored in the memory unit 28 in the form of instructions executable by the processor(s) 26, it being understood that the process 100 may alternatively be implemented and/or executed in any conventional manner. The process 100 will be further described below in the context of a quadrupole device 18, although it will be understood that in alternate embodiments the multi-pole device 18 may have any number (greater than or equal to 2) of pairs of poles as described above.

The process 100 illustratively begins at step 102 where the various settings of the AC source 48 of the voltage source V2 are selected which define the AC voltage to be applied by the voltage source V2 to the quadrupole 18. In some embodiments, the settings may be selected at step 102 via manual selection using one or more input devices included in the one or more peripheral devices 36 operatively coupled to the processor(s) 26, although in alternate embodiments at least some of the settings may be selected manually on the voltage source V2 or the voltage source V2 may be configured to be programmed to establish one or more of the settings. In any case, the settings may illustratively include, but are not limited to, a peak amplitude (P) of the AC voltage, an initial frequency (IF) of the AC voltage, frequency endpoints (F1, F2) defining a range of frequencies of the AC voltage between which the AC voltage is to be changed, a step size (S) defining a value via which the frequency of the AC voltage is to be increased and/or decreased, a waveform shape (WS) corresponding to the shape of the AC voltage, a frequency change period (CP) corresponding to the duration of one period of frequency change, and frequency change duration (CD) corresponding to the total duration of frequency changing. In some embodiments, the waveform shape of the AC voltage produced by the AC source 48 may be a sinusoidal waveform, although in alternate embodiments, the AC voltage produced by the AC source 48 may have any waveform shape. In the illustrated embodiment, the AC voltage applied to the quadrupole 18 via the outputs N1, N2 (see FIG. 2) illustratively has a 50% duty cycle, although in alternate embodiments, the duty cycle of the AC voltage may have any value and duty cycle may be included in the settings that are selectable at step 102. In some embodiments, the peak amplitude P and the initial frequency (IF) may be selected in a conventional manner based on the range of charged particle m/z values (or range of charged particle masses and/or charge values) of interest, and the frequency endpoints F1, F2 may then be selected to be frequencies below and/or above the initial frequency IF. In some embodiments, the initial frequency may serve as a center frequency such that IF−F1=F2−IF, although in alternate embodiments F1 may be any frequency below IF and F2 may be any frequency above IF, i.e., such that F1≤IF≤F2. In other embodiments, the initial frequency IF may serve as F1 or F2, i.e., such that the frequency F of the AC voltage source 48 is to be varied between IF and F2 or between F1 and IF.

In the embodiment of the process 100 illustrated in FIG. 5, the AC source 48 of the voltage source V2 is operated at different frequencies by sweeping the frequency of the AC voltage produced by the AC source 48 back and forth between two endpoint frequencies F1 and F2. One example of such a frequency sweep profile 120 is illustrated in FIG. 6, in the form of a triangular waveform shape in which an initial (or, base) frequency (IF) 122 is 450 kHz and is swept between 440 kHz (F1) and 460 kHz (F2) with a step size (S) of 1 kHz, in which the change period (CP) between a full sweep from F1 to F2 and from F2 back to F1 is 120 seconds, and in which the change duration during which the AC voltage is swept between F1 and F2 and then from F2 back to F1 is 600 seconds (e.g., for a total of 5 sweeps). It will be understood that the settings of the AC source 48 depicted in FIG. 6 and just described are provided only by way of example and that the value(s) of one or more of these settings may be different in other embodiments. In some alternate embodiments, the AC voltage produced by the AC source 48 may be swept one or more times only from a low frequency to a high frequency, or may be swept one or more times only from a high frequency to a low frequency. In other alternate embodiments the AC source 48 of the voltage source V2 may be operated at different frequencies by changing the frequency of the AC voltage produced by the AC source 48 between two different frequency endpoints according to any desired pattern or randomly. In any case, the frequency of the AC voltage produced by the AC voltage source 48 may be changed once (for a total of two different frequencies), or any number of times, and with a frequency sweep profile having any desired waveform shape.

In some embodiments in which the quadrupole 18 may be operated as a mass-to-charge filter, as described above, the voltage source V2 may include the DC source 49 and the process 100 may include step 104 (as shown by dashed-line representation) to which the process 100 advances from step 102. In embodiments which include step 104, the settings of the DC source 49 of the voltage source V2 are selected which define the magnitude of the DC voltage to be applied by the voltage source V2 to the quadrupole 18, e.g., via an input device included in the peripheral device(s) 36 or via manual or programmed control of the DC source 49. In any case, the processor(s) 26 is/are illustratively operable at step 104 to control the DC source 49 to apply the selected DC voltage to the quadrupole 18. In alternate embodiments, the DC voltage supply 49 may be controlled manually or by another processor or other circuitry to apply the selected DC voltage to the quadrupole 18.

In embodiments that include step 104, the process 100 advances from step 104 to step 106, and in embodiments that do not include step 104 the process 100 advances from step 102 to step 106. In any case, the processor(s) 100 is/are illustratively operable at step 106 to control the voltage source V2 to change the frequency F of the AC voltage produced by the AC voltage source 48 between F1 and F2 according to the settings of the AC source 48 selected at step 102. In embodiments in which the settings of the AC source 48 correspond to those illustrated by example in FIG. 6, the processor(s) 26 is/are operable at step 106 to control V2 to sweep the AC voltage produced by the AC source 48 between 440 kHz and 460 kHz and then from 460 kHz back to 440 kHz with a step size of approximately 0.32 kHz and a sweep period of 120 seconds a total of 5 times, although other step sizes, sweep periods and/or total execution times may alternatively be used.

For each step of the frequency F of the AC voltage produced by the AC source 48 at step 106, the charged particle analyzer(s) 24 is/are operable at step 108 to analyze the corresponding charged particles exiting the multi-pole (MP) device 18 and the processor(s) 26 is/are operable at step 108 to record the results of such analysis, i.e., the charged particle detection data, by the charged particle analyzer(s) 24. At the end of the selected change duration CD, the process 100 advances to step 110 where the processor(s) 26 is/are operable to average the charged particle detection data recorded at each frequency step of the AC source 48 during the selected change duration CD, and at step 112 the processor(s) 26 is/are then operable to generate and produce a spectrum of the averaged charged particle detection data, e.g., via a printer and/or a visual display monitor.

Referring now to FIGS. 7B and 8B, an example m/z spectrum 140 (FIG. 7B) and a corresponding example mass and charge scatter plot spectrum 160 (FIG. 8B) are shown in which the instrument 10 of FIG. 1 was used, with the quadrupole 18 operated as an RF-only quadrupole driven by a sinusoidal RF voltage source V2 and controlled according to the process 100 illustrated by example in FIG. 5 (omitting step 104) to sweep back and forth between frequency endpoints of 440 kHz and 460 kHz as illustrated by example in FIG. 6, to analyze the same sample of plasmid pBR322 vector that produced the spectrums 130 and 150 of FIGS. 7A and 8A described above.

The plots 140, 160 of FIGS. 7B and 8B, as compared with the plots 130, 150 of FIGS. 7A and 8A respectively, illustratively demonstrate the elimination, or near elimination, of the quadrupole noding effect depicted in FIGS. 7A and 8A by using the process 100 illustrated in FIG. 5. As depicted in FIG. 7B, for example, the m/z spectrum 140 shows a single broad peak because the charged particle sub-populations missing in FIG. 7A are now being transmitted from the charged particle outlet 20 of the quadrupole 18 to the charged particle inlet 22 of the charged particle analyzer(s) 24, and filling the gaps depicted in the m/z spectrum 130 of FIG. 7A. Likewise, the two sets 162, 164 of charge points in FIG. 8B each appear as single groups of charges without the several distinct streaks of points and blank areas therebetween as depicted in FIG. 8A. Thus, by varying the frequency of the RF voltage applied to the rods of the quadrupole 18, such as by using the process 100 depicted by example in FIG. 5, the effect of quadrupole noding can be eliminated, or at least mitigated, which results in improvements in in accuracy of the generated spectrums.

Differences in trajectories of charged particles exiting the charged particle outlet 20 of the quadrupole 18 (or other multi-pole instrument), as described above, is also dependent on the peak amplitude of the AC voltage produced by the AC source 48. That is, the point of exit of a charged particle having a particular m/z from the charged particle outlet 20 of the quadrupole 18, relative to the central, longitudinal axis 34, is also a function of the peak amplitude of the AC source 48 as is evident from the potential well equation provided above. Accordingly, the noding effect described above may alternatively be eliminated, or at least greatly reduced, by operating the AC voltage source 48 at a fixed, i.e., constant, frequency but at different peak amplitudes to shift the m/z-dependent exit points of charged particles from the charged particle outlet 20 of the quadrupole 18 (or other multi-pole device) between and along the node 34 and the anti-node(s), and then averaging the charged particle detection data acquired by downstream charge particle analyzer(s) 24, similarly to the frequency-varying approach described above.

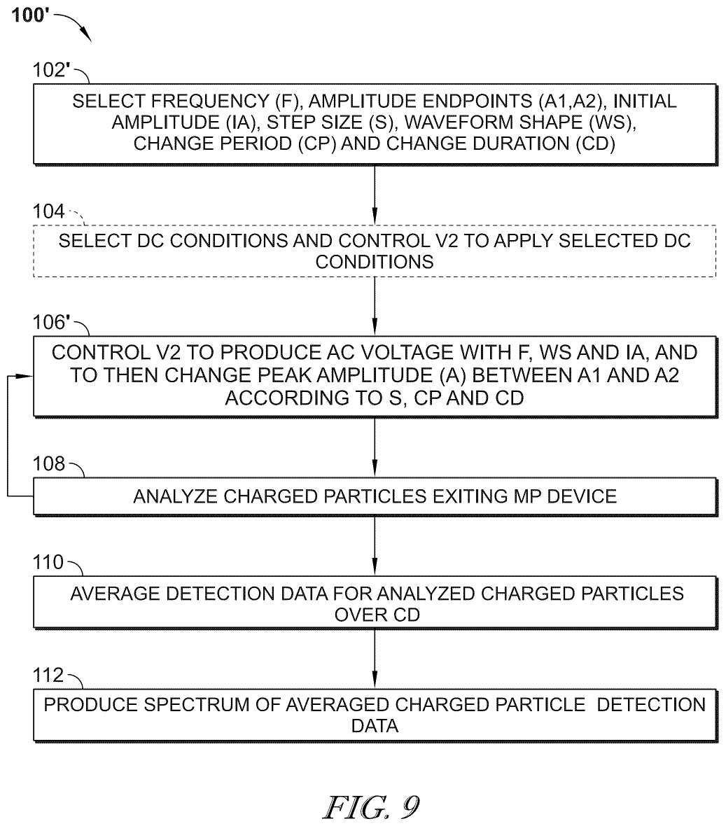

In this regard, a flowchart is shown in FIG. 9 of an example process 100′ for operating the AC source 48 of the voltage source V2 at different peak amplitudes to eliminate, or at least reduce, the noding effect of any multi-pole device 18 on acquired charged particle measurement data. The process 100′ is identical in many respects to the process 100 illustrated in FIG. 5 and described above, and like steps are therefore identified with like reference numbers, it being understood that executions of such like steps will proceed as described above. In one embodiment, the process 100′ is implemented in the form of instructions stored in the memory device 28 and executable by the processor(s) 26 to control the voltage source V2 of FIG. 1 as will be described below. In some alternative embodiments, the process 100 may be implemented, in whole or in part, by one or more other processors and/or by circuitry on-board the voltage source V2. In some alternative embodiments, the process 100′ may be implemented, in whole or in part, by hardware forming at least part of the processor(s) 26 and/or by off-board circuitry. In any case, the process 100′ will be described as being stored in the memory unit 28 in the form of instructions executable by the processor(s) 26, it being understood that the process 100′ may alternatively be implemented and/or executed in any conventional manner. The process 100′ will be further described below in the context of a quadrupole device 18, although it will be understood that in alternate embodiments the multi-pole device 18 may have any number (greater than or equal to 2) of pairs of poles as described above.

The process 100′ illustratively differs from the process 100 described above in that step 102′ of the process 100′ replaces step 102 of the process 100. In step 102′, as in step 102, the various settings of the AC source 48 of the voltage source V2 are selected which define the AC voltage to be applied by the voltage source V2 to the quadrupole 18. In some embodiments, the settings may be selected at step 102′ via manual selection using one or more input devices included in the one or more peripheral devices 36 operatively coupled to the processor(s) 26, although in alternate embodiments at least some of the settings may be selected manually on the voltage source V2 or the voltage source V2 may be configured to be programmed to establish one or more of the settings. In any case, several settings selected in step 102′ are common with those of step 102, such as step size (S), waveform shape (WS), change period (CP) and change duration (CD), all as described above. Additionally, as described above with respect to the process 100, the duty cycle of the AC voltage produced by the AC source 48 may be set at any desired value, e.g., 50%, although in alternate embodiments the duty cycle of the AC voltage may have any value and duty cycle may be included in the settings that are selectable at step 102′.

Step 102′ illustrative differs from step 102 in that the settings include, an operating frequency (F), an initial peak amplitude (IA), and peak amplitude endpoints (A1, A2). The operating frequency F is illustratively the initial frequency IF selected as described above, e.g., based on the range of charged particle m/z values (or range of charged particle masses and/or charge values) of interest, although in alternate embodiments the operating frequency F may be set to a frequency other than IF. In some embodiments, the initial peak amplitude (IA) may also be selected in a conventional manner, e.g., based on the range of charged particle m/z values (or range of charged particle masses and/or charge values) of interest, and the peak amplitude endpoints A1, A2 may then be selected to be peak amplitudes below and/or above the initial peak amplitude IA. In some embodiments, the initial peak amplitude IA may serve as a center amplitude or mid-point amplitude such that IA−A1=A2−IA, although in alternate embodiments A1 may be any peak amplitude below IA and A2 may be any peak amplitude above IA, i.e., such that A1≤IA≤A2. In other embodiments, the initial peak amplitude IA may serve as A1 or A2, i.e., such that the peak amplitude A of the AC voltage source 48 is to be varied between IA and A2 or between A1 and IA.

Some embodiments of the process 100′ may include step 104 as described above. In embodiments of the process 100′ which include step 104, the process 100′ advances from step 104 to step 106′, and in embodiments which do not include step 104 the process 100′ advances from step 102 to step 106′. In any case, step 106′ illustratively differs from step 106 of the process 100 described above in that the processor(s) 100 is/are illustratively operable at step 106′ to control the voltage source V2 to change the peak amplitude A of the AC voltage produced by the AC voltage source 48 between A1 and A2 according to the settings of the AC source 48 selected at step 102′. In one example embodiment, which should not be considered to be limiting in any way, the processor(s) 26 is/are operable at step 106′ to control V2 to establish the AC voltage produced by the AC source 48 as a 380 kHz, 230V peak-to-peak sine wave, and to then sweep the AC voltage produced by the AC source 48 between using a supplemental 0 to 47V, 10 Hz triangular waveform applied to the 230V peak-to-peak waveform using for example, the same step size, sweep period and total sweep time as described above with reference to FIG. 6, although other step sizes, sweep periods and/or total execution times may alternatively be used. It will be understood that the settings of the AC source 48 just described are provided only by way of example and that the value(s) of one or more of these settings may be different in other embodiments. In some alternate embodiments, the AC voltage produced by the AC source 48 may be swept one or more times only from a low supplemental voltage to a high supplemental voltage, or may be swept one or more times only from a high supplemental voltage to a low supplemental voltage. In other alternate embodiments the AC source 48 of the voltage source V2 may be operated at different peak amplitudes by changing the peak amplitude of the AC voltage produced by the AC source 48 between two different peak amplitude endpoints according to any desired pattern or randomly. In any case, the peak amplitude of the AC voltage produced by the AC voltage source 48 may be changed once (for a total of two different peak amplitudes) or any number of times. Following step 106′, the process 100′ further includes steps 108-112 all as described above with respect to FIG. 5.

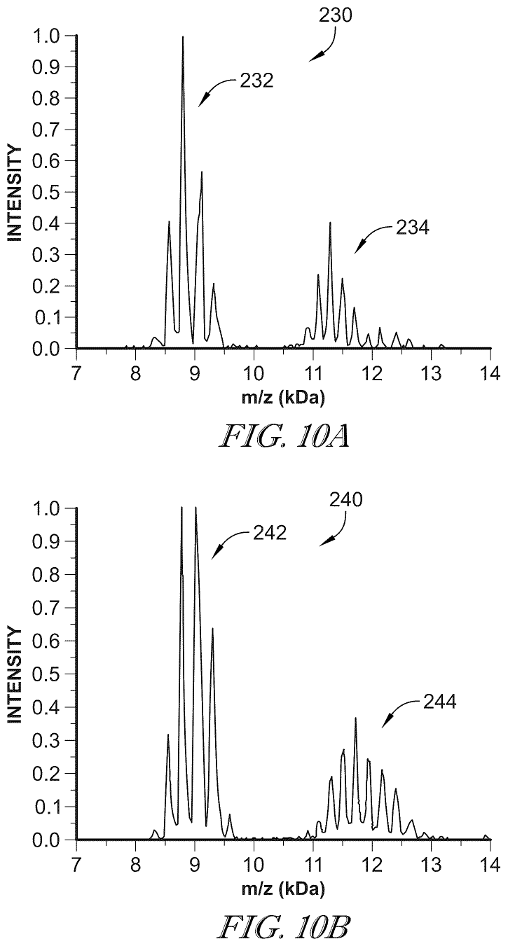

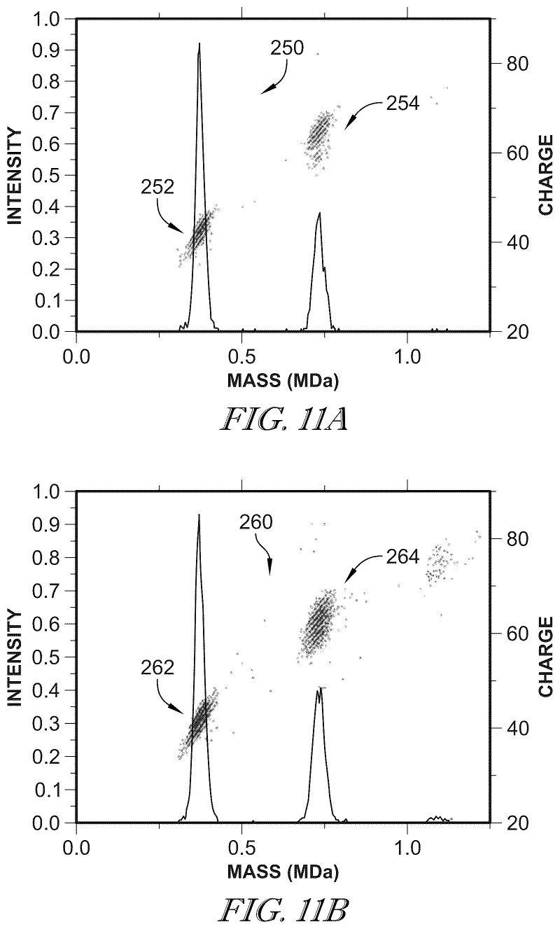

Referring to FIGS. 10A and 11A, the noding effect described above is again demonstrating with different sample than used in FIGS. 7A-8B. In the example plots of FIGS. 10A and 11A, an example m/z spectrum 230 (FIG. 10A) and an example mass and charge scatter plot (mass and charged distributions overlaid onto one another) spectrum 250 (FIG. 11A) are shown in which the instrument 10 of FIG. 1 was used, with the quadrupole 18 operated as an RF-only quadrupole driven by a sinusoidal RF voltage source V2 at a frequency of approximately 380 kHz, to analyze a sample of Glutamate Dehydrogenase (“GDH”) having a known monomer masses clustered around 0.33 MDa and known dimer masses clustered around 0.65 MDa. Like the plots 130, 150 of FIGS. 7A and 8A, the plots 230, 250 of FIGS. 10A and 11A demonstrate the effects of quadrupole noding, as defined and described above. As depicted in FIG. 10A, for example, the effect of noding in the quadrupole 18 is visible in the form of distortions in the monomer charge state distribution 232 and in the dimer charge state distribution 234 of the m/z spectrum 230. Likewise, in the mass and charge scatter plot of FIG. 11A, broad extinction of certain charge states is clearly visible in both of the monomer charge state distribution 252 and in the dimer charge state distribution 254. With the GDH sample described above, the distortions in the dimer charge state distributions 234, 254 are particularly pronounced.

Referring now to FIGS. 10B and 11B, an example m/z spectrum 240 (FIG. 10B) and a corresponding example mass and charge scatter plot spectrum 260 (FIG. 11B) are shown in which the instrument 10 of FIG. 1 was used, with the quadrupole 18 operated as an RF-only quadrupole driven by a sinusoidal RF voltage source V2 and controlled according to the process 100′ illustrated by example in FIG. 9 (omitting step 104) to sweep back and forth between peak amplitude endpoints of 0 V and 47V as described above, to analyze the same sample of GDH that produced the spectrums 230 and 250 of FIGS. 10A and 11A described above.

The plots 240, 260 of FIGS. 10B and 11B, as compared with the plots 230, 250 of FIGS. 10A and 11A respectively, illustratively demonstrate the elimination, or near elimination, of the quadrupole noding effect depicted in FIGS. 10A and 11A by using the process 100′ illustrated in FIG. 9. As depicted in FIG. 10B, for example, the m/z spectrum 240 more closely resembles the expected distribution of charge states for the monomer 242 and for the dimer 244 (as compared with the plot 230 of FIG. 10A), and the monomer charge state distribution 262 and dimer charge state distribution 264 of the mass and charge scatter plot 260 of FIG. 11B are more densely populated as compared with the plot 250 of FIG. 11A. Thus, by varying the peak amplitude of the RF voltage applied to the rods of the quadrupole 18, such as by using the process 100′ depicted by example in FIG. 9, the effect of quadrupole noding can be eliminated, or at least mitigated, which results in improvements in in accuracy of the generated spectrum.

Differences in trajectories of charged particles exiting the charged particle outlet 20 of the quadrupole 18 (or other multi-pole instrument), as described above, is also dependent on the waveform shape of the AC voltage produced by the AC source 48. That is, the point of exit of a charged particle having a particular m/z from the charged particle outlet 20 of the quadrupole 18, relative to the central, longitudinal axis 34, is also a function of the waveform shape of the AC voltage produced by the AC source 48. Accordingly, the noding effect described above may alternatively be eliminated, or at least greatly reduced, by operating the AC voltage source 48 at a fixed, i.e., constant, frequency and at a fixed, i.e., constant peak voltage, but with different waveform shapes to shift the m/z-dependent exit points of charged particles from the charged particle outlet 20 of the quadrupole 18 (or other multi-pole device) between and along the node 34 and the anti-node(s), and then averaging the charged particle detection data acquired by downstream charge particle analyzer(s) 24, similarly to the frequency-varying approach described above.

In this regard, the process 100 illustrated by example in FIG. 5 or the process 100′ illustrated by example in FIG. 9 may be modified to control the AC source 48 of the voltage source V2 to operate with different waveform shapes in order to eliminate, or at least reduce, the noding effect of any multi-pole device 18 on acquired charged particle measurement data. In the modified process 100 100′, several steps may be identical to those of the process 100, 100′ as described above, and executions of such like steps will proceed as described above.

The modified process 100, 100′ illustratively differs from the process 100, 100′ described above in that step 102, 102′ the various settings of the AC source 48 of the voltage source V2 are selected which define the AC voltage to be applied by the voltage source V2 to the quadrupole 18, but no frequency or peak amplitudes are specified. The modified process 100, 100′ illustratively further differs from the process 100, 100′ described above in that step 106, 106′ operates to change the waveform shape (WS) of the AC voltage produced by the AC source 48 of V2 rather than to change the frequency or peak amplitude of the AC voltage. In one embodiment of the modified process 100, 100′, the AC source 48 may be capable of producing waveforms of two or more different waveform shapes, some examples of which are described above with respect to the description of FIG. 2. In such embodiments, the modified step 106, 106′ may be carried out by changing the waveform shape two or more times, each with a different waveform shape. In some alternate embodiments of the modified process 106, 106′, the AC source 48 may be a conventional arbitrary waveform generator (AWG) as described above, and in such embodiments the modified step 106, 106′ may be carried out by gradually changing from one waveform shape to the next over a selected change period (CP) using a selected step size (S) of waveform changes. In such embodiments, the waveform shape may be gradually changed between two or different waveform shapes over a total change duration (CD).

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected. For example, whereas three different process 100, 100′ and a modified 100, 100′ are described for eliminating, or at least greatly reducing, the noding effect, each by modifying in a different manner the AC voltage produced by the AC voltage source 48, it will be understood that any combination of such processes may be combined to produce further modified processes for controlling the AC voltage produced by the AC voltage source 48, e.g., to change both the frequency and peak voltage, to change both the frequency and waveform shape, to change both the peak voltage and waveform shape, and/or to change each of the frequency, peak voltage and waveform shape.

What is claimed is:

1. A method for controlling a multi-pole charged particle transmission device having an even number of elongated rods spaced apart radially about a central axis extending axially through the device from a charged particle inlet at one end of the device to a charged particle outlet at an opposite end of the device, the method comprising:
controlling an AC voltage source to apply an AC voltage, having a frequency set to a first frequency, having a peak amplitude set to a first amplitude and having a waveform shape set to a first waveform shape, to the rods of the multi-pole charged particle transmission device,
passing a set of charged particles through the charged particle transmission device with the frequency of the applied AC voltage at the first frequency, with the peak amplitude of the applied AC voltage at the first amplitude, and with the waveform shape of the AC voltage set to the first waveform shape,
controlling the AC voltage source to change one of the frequency of the AC voltage to a second frequency different from the first frequency, the peak amplitude of the AC voltage to a second amplitude different from the first amplitude, or the waveform shape of the AC voltage to a second waveform shape different from the first waveform shape, and
passing another set of the charged particles through the charged particle transmission device with the one of the frequency of the applied AC voltage at the second frequency, the peak amplitude of the applied AC voltage at the second amplitude, or the waveform shape of the AC voltage having the second waveform shape.

2. The method of claim 1, further comprising, prior to controlling the AC source to change the one of the frequency of the AC voltage to the second frequency or the peak amplitude of the AC voltage to the second amplitude,
(i) controlling the AC voltage source to advance the one of the frequency of the applied AC voltage by a first selected step size toward the second frequency, or the peak amplitude of the AC voltage by the first selected step size to toward the second amplitude, followed by
(ii) passing a new set of the charged particles through the charged particle transmission device with the one of the frequency of the applied AC voltage at the advanced frequency, or the peak amplitude of the AC voltage at the advanced amplitude, and
(iii) executing (i) and (ii) until the one of the advanced frequency reaches the second frequency, or the advanced amplitude reaches the second amplitude.

3. The method of claim 2, further comprising, after the one of the advanced frequency reaches the second frequency, or the advanced amplitude reaches the second amplitude,
(iv) controlling the AC voltage source to advance the one of the frequency of the applied AC voltage by a second selected step size back toward the first frequency, or the peak amplitude of the AC voltage by the second selected step size back toward the first amplitude, followed by
(v) passing another new set of the charged particles through the charged particle transmission device with the one of the frequency of the applied AC voltage at the advanced frequency, or the peak amplitude of the AC voltage at the advanced amplitude, and
(vi) executing (iv) and (v) until the one of the advanced frequency reaches the first frequency, or the peak amplitude reaches the first amplitude.

4. The method of claim 3, further comprising executing a selected number of times, (i)-(iii) and followed by (iv)-(vi).

5. The method of claim 2, further comprising completing (iii) within a selected time period.

6. The method of claim 3, further comprising completing (vi) within a selected time period.

7. The method of claim 3, further comprising completing each execution of (i)-(iii) and (iv)-(vi) within a selected time period.

8. The method of claim 1, wherein controlling the AC voltage source comprises controlling the AC voltage source to change the frequency of the AC voltage, the method further comprising:
selecting a base frequency of the AC voltage produced by the AC voltage source as a function of mass-to-charge ratios of the charged particles to be passed through the multi-pole charged particle transmission device, and
selecting the first and second frequencies, wherein the second frequency is greater than the first frequency, such that the base frequency is between the first and second frequencies, such that the base frequency is the first frequency, or such that the base frequency is the second frequency.

9. The method of claim 1, wherein controlling the AC voltage source comprises controlling the AC voltage source to change the peak amplitude of the AC voltage, the method further comprising:
selecting a base peak amplitude of the AC voltage produced by the AC voltage source as a function of mass-to-charge ratios of the charged particles to be passed through the multi-pole charged particle transmission device, and
selecting the first and second amplitudes, wherein the second amplitude is greater than the first amplitude, such that the base peak amplitude is between the first and second amplitudes, such that the base peak amplitude is the first amplitude, or such that the base peak amplitude is the second amplitude.

10. The method of claim 1, wherein only the AC voltage is applied to the rods such that the multi-pole charged particle transmission device operates as a multi-pole charged particle guide.

11. The method of claim 1, further comprising controlling a DC voltage source to also apply a DC voltage to the rods of the multi-pole charged particle transmission device such that the multi-pole charged particle transmission device operates as a multi-pole charged particle mass-to-charge ratio filter.

12. The method of claim 11, further comprising:
selecting a magnitude of the DC voltage which defines a corresponding range of mass-to-charge ratios to pass through the multi-pole charged particle mass-to-charge ratio filter, and
controlling the DC voltage source to apply the DC voltage with the selected magnitude to the rods of the multi-pole charged particle mass-to-charge ratio filter so as to pass through the multi-pole charged particle mass-to-charge ratio filter only charged particles having mass-to-charge ratios within the corresponding range of mass-to-charge ratios.

13. A method for analyzing charged particles generated by a source of charged particles, the method comprising:
receiving the generated charged particles in the charged particle inlet of the multi-pole charged particle transmission device,
controlling a multi-pole charged particle transmission device according to claim 1,
for each set of charged particles passing through the multi-pole charged particle transmission device, measuring with at least one charged particle analyzer mass-to-charge ratios of the charged particles in the respective set of charged particles exiting the charged particle outlet of the multi-pole charged particle transmission device, and
averaging the measured mass-to-charge ratios of the charged particles in all of the respective sets of charged particles to produce a resulting set of mass-to-charge ratios of the generated charged particles.

14. The method of claim 13, further comprising:
for each set of charged particles passing through the multi-pole charged particle transmission device, measuring with the at least one charged particle analyzer, charge magnitudes of the charged particles in the respective set of charged particles exiting the charged particle outlet of the multi-pole charged particle transmission device,
averaging the measured charge magnitudes of the charged particles in all of the respective sets of charged particles to produce a resulting set of charge magnitudes of the generated charged particles, and
determining, from the resulting set of mass-to-charge ratios and the resulting set of charge magnitudes, a resulting set of masses of the generated charged particles.

15. A method for analyzing a sample, the method comprising:
controlling a charged particle source to generate charged particles from the sample,
receiving the generated charged particles in a charged particle inlet of a multi-pole charged particle transmission device having an even number of elongated rods spaced apart radially about a central axis extending axially through the device from the charged particle inlet at one end of the device to a charged particle outlet at an opposite end of the device,
controlling an AC voltage source to apply to the rods of the multi-pole charged particle transmission device an AC voltage having a frequency set to a first frequency, a peak amplitude set to a first amplitude, and a waveform shape set to a first waveform shape,
passing a set of the generated charged particles through the charged particle transmission device with the frequency of the applied AC voltage at the first frequency, the peak amplitude of the applied AC voltage at the first amplitude, and the waveform shape of the applied AC voltage having the first waveform shape,
measuring, with at least one charged particle analyzer, mass-to-charge ratios of the charged particles in the set of charged particles exiting the charged particle outlet of the multi-pole charged particle transmission device,
controlling the AC voltage source to change one of the frequency of the AC voltage to a second frequency different from the first frequency, the peak amplitude of the AC voltage to a second amplitude different from the first amplitude, or the waveform shape of the AC voltage to a second waveform shape different from the first waveform shape,
passing another set of the charged particles through the charged particle transmission device with the one of the frequency of the applied AC voltage at the second frequency, the peak amplitude of the applied AC voltage at the second amplitude, or the waveform shape of the applied AC voltage having the second waveform shape,
measuring, with at least one charged particle analyzer, mass-to-charge ratios of the charged particles in the another set of charged particles exiting the charged particle outlet of the multi-pole charged particle transmission device, and
averaging the measured mass-to-charge ratios of the charged particles in the set and the another set of charged particles to produce a resulting set of mass-to-charge ratios of the generated charged particles.

16. The method of claim 15, further comprising:
measuring with the at least one charged particle analyzer charge magnitudes of the charged particles in the set of charged particles exiting the charged particle outlet of the multi-pole charged particle transmission device,
measuring with the at least one charged particle analyzer charge magnitudes of the charged particles in the another set of charged particles exiting the charged particle outlet of the multi-pole charged particle transmission device,
averaging the measured charge magnitudes of the charged particles in the set and the another set of charged particles to produce a resulting set of charge magnitudes of the generated charged particles, and
determining, from the resulting set of mass-to-charge ratios and the resulting set of charge magnitudes, a resulting set of masses of the generated charged particles.

17. The method of claim 15, further comprising, prior to controlling the AC source to change the one of the frequency of the AC voltage to the second frequency or the peak amplitude of the AC voltage to the second amplitude,
(i) controlling the AC voltage source to advance the one of the frequency of the applied AC voltage by a first selected step size toward the second frequency, or the peak amplitude of the applied AC voltage by the first selected step size toward the second amplitude, followed by
(ii) passing a new set of the charged particles through the charged particle transmission device with the one of the frequency of the applied AC voltage at the advanced frequency, or the peak amplitude of the AC voltage at the advanced amplitude, followed by
(iii) measuring with the at least one charged particle analyzer mass-to-charge ratios of the charged particles in the new set of charged particles exiting the charged particle outlet of the multi-pole charged particle transmission device, and
(iv) executing (i) through (iii) until the one of the advanced frequency reaches the second frequency or the advanced amplitude reaches the second amplitude,
wherein averaging the measured mass-to-charge ratios comprises averaging the measured mass-to-charge ratios of the charged particles in the set of charged particles, in the another set of charged particles and in all of the new sets of charged particles to produce the resulting set of mass-to-charge ratios of the generated charged particles.

18. The method of claim 17, wherein (iii) further comprises measuring with the at least one charged particle analyzer charge magnitudes of the charged particles in the new set of charged particles exiting the charged particle outlet of the multi-pole charged particle transmission device,
and wherein averaging the measured charge magnitudes comprises averaging the measured charge magnitudes of the charged particles in the set of charged particles, in the another set of charged particles and in all of the new sets of charged particles to produce the resulting set of charge magnitudes of the generated charged particles.

19. The method of claim 17, further comprising, after the one of the advanced frequency reaches the second frequency or the advanced amplitude reaches the second amplitude,
(v) controlling the AC voltage source to advance the one of the frequency of the applied AC voltage by a second selected step size back toward the first frequency, following, or to advance the peak amplitude of the applied AC voltage by the second selected step size back toward the first amplitude, by
(vi) passing another new set of the charged particles through the charged particle transmission device with the one of the frequency of the applied AC voltage at the advanced frequency, or with the peak amplitude of the applied AC voltage at the advanced amplitude,
(vii) measuring with the at least one charged particle analyzer mass-to-charge ratios of the charged particles in the another new set of charged particles exiting the charged particle outlet of the multi-pole charged particle transmission device, and
(viii) executing (v) through (vii) until the one of the advanced frequency reaches the first frequency or the advanced amplitude reaches the first amplitude,
wherein averaging the measured mass-to-charge ratios comprises averaging the measured mass-to-charge ratios of the charged particles in the set of charged particles, in the another set of charged particles, in all of the new sets of charged particles and in all of the another new sets of charged particles to produce the resulting set of mass-to-charge ratios of the generated charged particles.

20. The method of claim 19, wherein (vii) further comprises measuring with the at least one charged particle analyzer charge magnitudes of the charged particles in the another new set of charged particles exiting the charged particle outlet of the multi-pole charged particle transmission device,
and wherein averaging the measured charge magnitudes comprises averaging the measured charge magnitudes of the charged particles in the set of charged particles, in the another set of charged particles, in all of the new sets of charged particles and in all of the another new sets of charged particles to produce the resulting set of charge magnitudes of the generated charged particles.

21. The method of claim 15, wherein controlling the AC voltage source comprises controlling the AC voltage source to change the frequency of the AC voltage, the method further comprising:
selecting a base frequency of the AC voltage produced by the AC voltage source as a function of mass-to-charge ratios of the charged particles to be passed through the multi-pole charged particle transmission device, and
selecting the first and second frequencies, wherein the second frequency is greater than the first frequency, such that the base frequency is between the first and second frequencies, such that the base frequency is the first frequency, or such that the base frequency is the second frequency.

22. The method of claim 15, wherein controlling the AC voltage source comprises controlling the AC voltage source to change the peak amplitude of the AC voltage, the method further comprising:
selecting a base peak amplitude of the AC voltage produced by the AC voltage source as a function of mass-to-charge ratios of the charged particles to be passed through the multi-pole charged particle transmission device, and
selecting the first and second amplitudes, wherein the second amplitude is greater than the first amplitude, such that the base peak amplitude is between the first and second amplitudes, such that the base peak amplitude is the first amplitude, or such that the base peak amplitude is the second amplitude.
